(19) United States
(12) Patent Application Publication
(10) Pub. No.: US 2014/0080326 A1
(43) Pub. Date: Mar. 20, 2014

(54) CONNECTOR

(71) Applicant: HON HAI PRECISION INDUSTRY CO., LTD., New Taipei (TW)

(72) Inventor: ZHENG-HENG SUN, New Taipei (TW)

(73) Assignee: HON HAI PRECISION INDUSTRY CO., LTD., New Taipei (TW)

(21) Appl. No.: 13/707,669

(22) Filed: Dec. 7, 2012

(30) Foreign Application Priority Data
Sep. 18, 2012 (CN) 2012103458826

(51) Int. Cl. H01R 12/51

(52) U.S. Cl. CPC H01R 12/51
USPC 439/59

(57) ABSTRACT

A connector for receiving an expansion card includes a base and a number of metal pins. A top of the base defines a slot. The slot extends through an end of the base. The metal pins are mounted inside the slot. Each metal pin extends through a bottom of the base to be electronically connected to corresponding traces on a motherboard.

### BACKGROUND

1. Technical Field

The present disclosure relates to a connector.

2. Description of Related Art

When seating most expansion card in an expansion slot of a motherboard of a computer, the expansion card must be perpendicular to the motherboard to properly seat the connector of the expansion card into the slot. However, if the side of the enclosure facing the motherboard cannot be or is difficult to be removed or not high enough above the motherboard to allow the connector of the expansion card to be inserted into the slot, it may be impossible to install the expansion card in the slot. This is an inconvenience.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the view.

FIG. 1 is an isometric view of an exemplary embodiment of a connector.

FIGS. 2-4 are schematic views showing an expansion card plugged into the connector of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

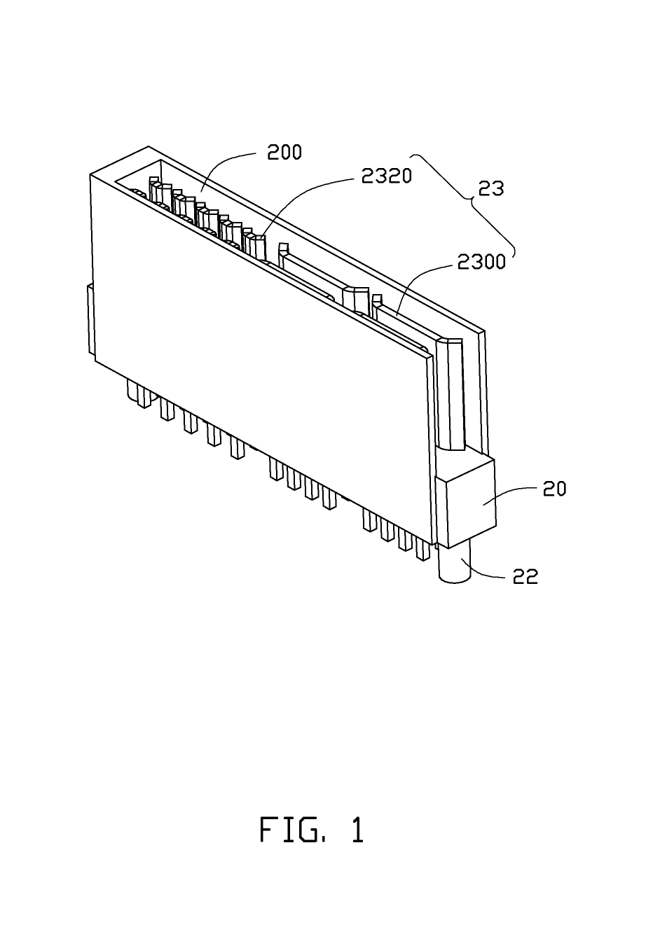

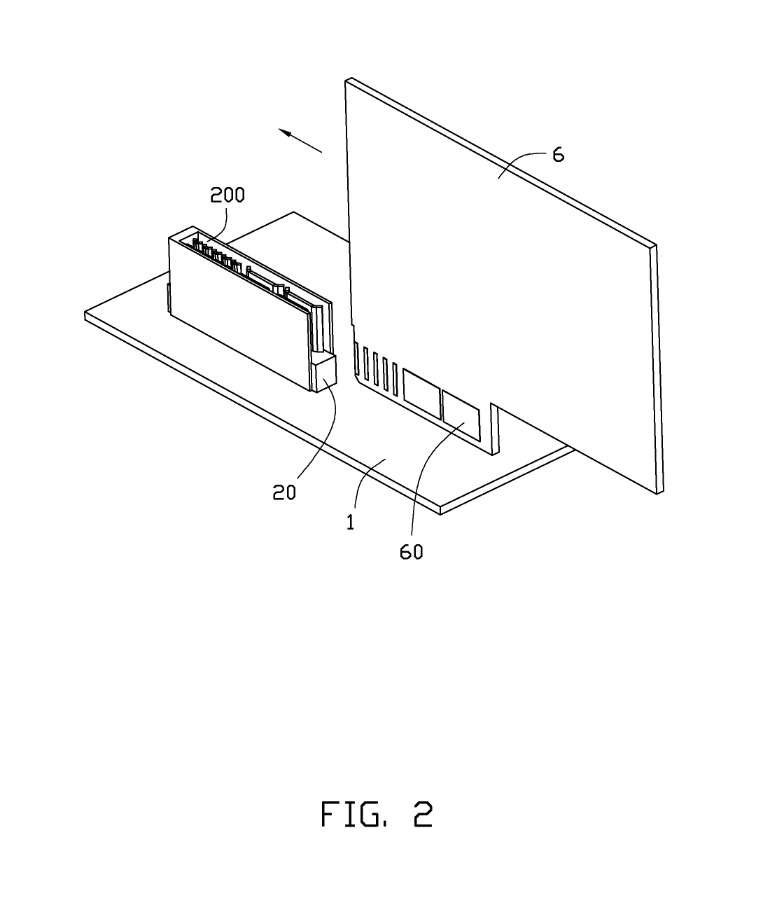

FIGS. 1 and 2 show an embodiment of a connector mounted on a printed circuit board (PCB) 1. The connector includes a base 20, two mounting pins 22, and a plurality of metal pins 23. In the embodiment, the metal pins 23 include power pins and signal pins.

A top of the base 20 defines a slot 200. The slot 200 extends through an end of the base 20. In other words, the slot 200 includes a lateral opening and a top opening. The metal pins 23 are mounted inside the slot 200. Each metal pin 23 extends through a bottom of the base 20. The mounting pins 22 perpendicularly extend down from a bottom surface of the base 20, and are used to fix the connector on the PCB 1.

When the connector is fixed on the PCB 1, the metal pins 23 are electronically connected to corresponding traces on the PCB 1. For example, the power pins of the metal pins 23 are electronically connected to power traces on the PCB 1, and the signal pins of the metal pins 23 are electronically connected to signal traces on the PCB 1.

In the embodiment, the metal pins 23 include four power pins and ten signal pins. Each power pin is a metal sheet 2300. Each signal pin is a metal sheet 2320. The four metal sheets 2300 are arranged in an array with two rows and two columns, and every two metal sheets 2300 in a same column are opposite to each other. The ten metal sheets 2320 are arranged in an array with two rows and five columns, and every two metal sheets 2320 in a same column are opposite to each other.

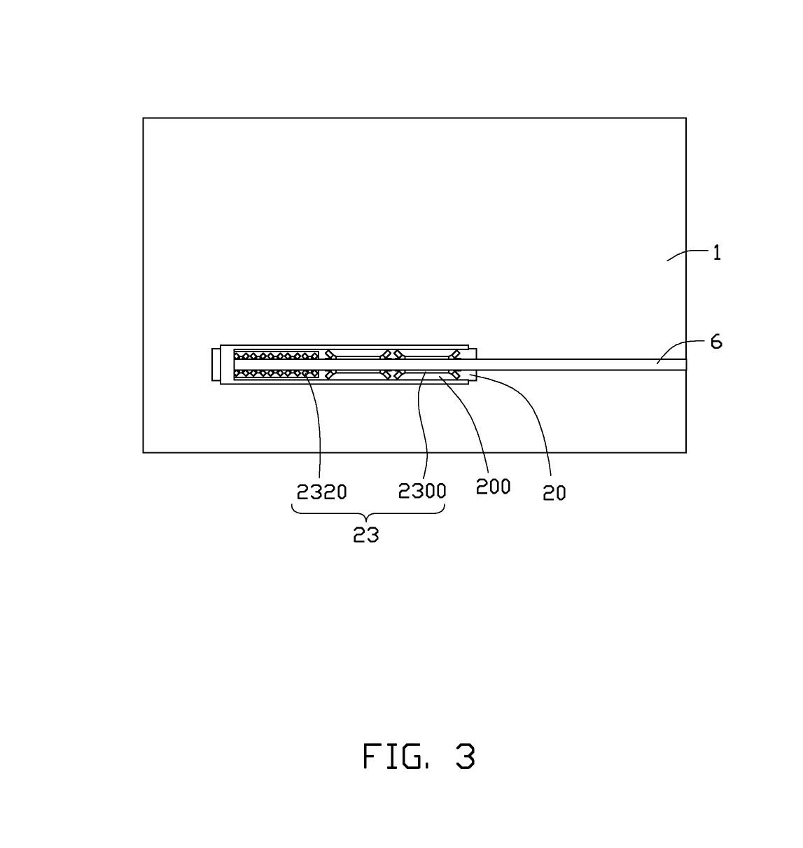

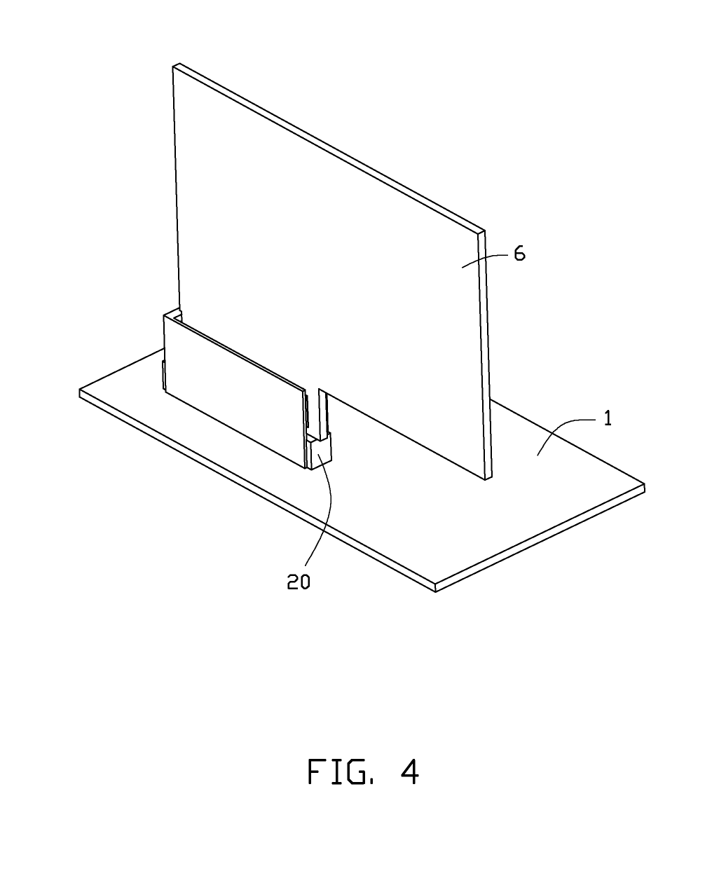

Referring to FIGS. 2-4, to install an expansion card 6, the card 6 is plugged into the slot 200 using either the top opening or the lateral opening of the slot 200 depending on available space around the connector. The card 6 is located between the two rows of metal sheets 2300 and 2320, such that edge connectors 60 on the card 6 contact with the metal sheets in the base 20. In the embodiment, a distance between every two opposite metal sheets is slightly less than a thickness of the card 6, such that the card 6 is stably fixed in the connector, and the edge connectors 60 firmly contact the metal sheets in the base 20.

In other embodiments, if the edge connectors are on only one side of the external card 6, the base 20 includes only one row of metal sheets. The other row of metal sheets can be replaced with non-conducting fixing sheets. When the card 6 is plugged into the connector, the metal sheets in the base 20 contact with the edge connectors 60, and the other side of the card 6 contacts with the non-conductive sheets, and the card 6 is fixed in the base 20.

The foregoing description of the exemplary embodiments of the disclosure has been presented only for the purposes of illustration and description and is not intended to be exhaustive or to limit the disclosure to the precise forms disclosed. Many modifications and variations are possible in light of disclosure above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A connector, comprising:
a base, wherein a top of the base defines a slot, the slot extends through an end of the base; and
a plurality of metal pins mounted inside the slot, wherein each metal pin extends through a bottom of the base.

2. The connector of claim 1, further comprising two mounting pins perpendicularly extending from a bottom surface of the base.

3. The connector of claim 1, wherein the metal pins are arranged in an array with two rows and two columns, and every two metal sheets in a same column are opposite to each other; a distance between every two opposite metal sheets is slightly less than a thickness of an expansion card to be connected with the connector.

4. The connector of claim 1, further comprising a plurality of fixing sheets, each fixing sheet is opposite to a metal sheet, a distance between a fixing sheet and a corresponding metal sheet is slightly less than a thickness of an expansion card to be connected to the connector.
